(19) United States
(12) Patent Application Publication
(10) Pub. No.: US 2025/0374864 A1
(43) Pub. Date: Dec. 11, 2025

(54) Bale length variation control system

(71) Applicant: Agroknot Solutions, LLC, Fortuna, MO (US)

(72) Inventor: Lynn L. Martin, Fortuna, MO (US)

(73) Assignee: Agroknot Solutions, LLC, Fortuna, MO (US)

(21) Appl. No.: 19/234,021

(22) Filed: Jun. 10, 2025

Related U.S. Application Data
(60) Provisional application No. 63/658,689, filed on Jun. 11, 2024.

(51) Int. Cl. A01F 15/08; A01F 15/04; A01F 15/14

(52) U.S. Cl. CPC A01F 15/0825; A01F 15/04; A01F 15/145

(57) ABSTRACT

Method, apparatus, and systems for controlling bale length of a bale in an agricultural baling machine are provided. The method may include monitoring length of twine for the bale using a sensor, determining if the length of twine reaches a threshold for the bale using a control module operatively connected to the sensor. After reaching the threshold, the method may include activating an actuator on the agricultural baling machine by the control module and tying the twine for the bale to secure the bale wherein the tying the twine is performed using a knotter of the agricultural baling machine activated with the actuator. The method may further include activating one or more bale stop members protruding into a bale chamber of the machine such that the one or more bale stop members stop movement of crop material to control the bale length when the length of twine reaches the threshold.

### RELATED APPLICATIONS

This application claims priority to U.S. Provisional Patent Application No. 63/658,689, file Jun. 11, 2024, hereby incorporated by reference in its entirety.

### FIELD OF THE DISCLOSURE

The present disclosure relates to square balers for baling crop material such as, but limited to, hay or straw. More particularly, but not exclusively, the present disclosure relates to a bale length variation control system for use with square balers.

### BACKGROUND

A baler is a type of agricultural machine which is used to gather and assemble crop material into a more convenient form, a bale, which is used to facilitate storage and handling of the crop material. Typical crop materials are hay or straw or grass although other types of crop materials may be used. For hay, typically a mower-conditioner is used to cut and condition the hay crop which dries in a windrow. For straw, a combine harvester discharges non-grain crop material which includes straw (e.g., wheat straw or oat straw) which may be picked up by a baler. The crop material is usually raked and dried into the windrow before baling and in operation the baler may run over the windrow to lift up the crop using tines in a reel of the baler and pack it into bales. The lifted crop material is then sent to a bale chamber having a plunger. The plunger is used to compress the crop material within the bale chamber. Once the material is compacted, as the bale is formed, a knotter may be used to encircle and tie a flexible restraint such as twine or wire around the exterior of the bale. Although there are balers of various types which produce bales of different sizes and dimensions, of particular interest here are square bales. In a square bale, the corners are generally square, but the bale will have a longer length than width or height.

One of the problems with balers used for producing square bales for hay or straw is inconsistency in bale length. There are a number of problems associated with bale length being too long. For example, longer bales may be more prone to breakage when being handled or transported. Longer bale length results in bales which may be difficult to handle manually which makes loading, unloading, and stacking more labor-intensive, and time consuming. Longer bale length can also result in storage problems as longer bales may not fit well or stack well which can make it more difficult to organize and maximize storage capacity in barns, storage sheds, or other storage locations.

The handling and transportation problems associated with longer bale length, shorter bale length and inconsistency in bale length further can result in the need to slow down overall operations from baling to transportation and storage. This inefficiency can lead to increased labor costs and lower productivity. Where there are narrow windows of time in which to perform baling operations due to changing weather conditions, even a small loss in productivity can be meaningful.

Long bales may also place additional strain on bundling equipment, bale stackers, bale accumulators, and the like which may lead to increased wear and tear and potentially higher maintenance and repair costs. Thus, excessively long hay bales, short hay bales, or otherwise inconsistent lengths of hay bales results in a range of issues.

### SUMMARY

Therefore, it is a primary object, feature, or advantage to improve over the state of the art.

It is a further object, feature, or advantage to provide a solution which allows for creating bales of a more consistent length, and to avoid creating bales of excessive length or excessively short bales.

It is a still further object, feature, or advantage to provide for a solution which may be integrated into a new baler thereby increasing the benefits and desirability of the baler.

Another object, feature, or advantage is to provide a solution which may be retrofit to an existing baler.

A further object, feature, or advantage is to provide one method of measuring all but the last flake of a bale and another method for measuring the last flake of the bale in order to provide consistency in bale length.

Another object, feature, or advantage is to provide for more accurately measuring bale length by measuring twine as opposed to using a star wheel.

A still further object, feature, or advantage is to use one method of measuring bale length for a first portion of a bale and a second method of measuring bale length for a last flake of the bale.

A still further object, feature, or advantage is to provide a higher resolution and more accurate method of measuring bale length.

One or more of these and/or other objects, features, or advantages will become apparent from the specification and claims that follow. No single embodiment need to provide each and every object, feature, or advantage. Different embodiments may have different objects, features, or advantages.

According to one aspect, a method may include monitoring length of twine for the bale using a sensor. The method may also include activating one or more bale stop members protruding into a bale chamber of the agricultural baling machine such that the one or more bale stop members stop movement of crop material to control the bale length when the twine length of the bale reaches a threshold. The method may further include tying the twine for the bale to secure the bale.

Each of the one or more bale stop members may be a bale stop roll. Each of the one or more bale stop rolls may include a traction mechanism attached thereon. The traction mechanism may include cleats. The sensor may include an electrical encoder. The tying the twine may be performed using a knotter of the agricultural baling machine.

According to another aspect, an apparatus may include a sensor configured to measure twine to determine when a threshold is reached for stoppage of a bale. The apparatus may also include a plurality of bale stop members configured to protrude into the bale chamber. The apparatus may furthermore include at least one actuator. The apparatus may in addition include each of the plurality of bale stop members operatively connected to one of the at least one actuator to provide for stopping movement of a first formed end of the bale when the bale reaches the threshold.

Each of the plurality of bale stop members may be operatively connected to an actuator. The actuator may be a hydraulic actuator. The apparatus may include an electronically activated shut off valve electrically connected to the sensor, the shut off valve fluidly connected to the hydraulic actuator such that activation of the shut off valve stops hydraulic fluid flow to each of the plurality of bale stop members thereby stopping movement of the plurality of bale stop members and limit length of the bale. Each of the bale stop members may be a bearing mounted rotated roll. The sensor may include an electrical encoder system. The apparatus may further include a control module operatively connected to the sensor. The apparatus may include a monitor in operative communication with the control module.

According to another aspect, the agricultural baler may include a bale chamber. The agricultural baler may also include at least one hydraulic actuator. The baler may furthermore include a sensor configured to measure twine to determine when a threshold is reached for stoppage of a bale. The baler may in addition include a plurality of bale stop rolls configured to protrude into the bale chamber. The baler may moreover include each of the plurality of bale stop rolls operatively connected to one of the at least one hydraulic actuators to provide for stopping movement of a first formed end of the bale when the bale reaches the threshold. Baler may also include a shutoff valve operatively connected to the at least one hydraulic actuator and configured to stop movement of each of the plurality of bale stop rolls.

The agricultural baler may include a control module operatively connected to the sensor and the shutoff valve. The agricultural baler may include a monitor in operative communication with the control module. The agricultural baler where the monitor may include a display with a user interface configured to receive a desired bale length from a user. The agricultural baler may be configured to check the bale prior to completion of forming the bale and change a length setting thereby adjusting timing of stopping movement of the plurality of bale stop rolls to control bale length. Implementations of the described techniques may include hardware, a method or process, or a computer tangible medium.

According to another aspect, a method may include monitoring length of twine for the bale using a sensor. The method may also include prior to completion of a plunger stroke associated with a last flake of the bale, determining if the twine length of the bale exceeds a threshold. The method may furthermore include in response to the bale length of twine exceeding the threshold, adjusting a setting associated with the bale to adjust timing of causing one or more bale stop members protruding into a bale chamber of the agricultural baling machine such that the one or more bale stop members stop movement of crop material to control the bale length. The method may in addition include causing the one or more bale stop members protruding into the bale chamber of the agricultural baling machine to stop to thereby limit bale length. The method may moreover include tying the twine for the bale to secure the bale at a desired length. The threshold may be a moving average of prior bale lengths. Implementations of the described techniques may include hardware, a method or process, or a computer tangible medium.

According to another aspect, a system may include a monitor having a display for in-cab use. The system may also include a control module in operative communication with the monitor. The system may furthermore include a sensor for monitoring twine length associated with a bale being formed by the agricultural baling machine, the sensor operatively connected to the control module. The monitor may be configured for displaying metrics associated with a baling operation.

The monitor may be configured to receive input for a user specifying a desired bale length. The system may include a needle frame sensor operatively connected to the control module. The system may include a plunger stroke sensor operatively connected to the control module. Implementations of the described techniques may include hardware, a method or process, or a computer tangible medium.

According to another aspect, a method of controlling bale length of a bale in an agricultural baling machine is provided. The method includes monitoring length of twine for the bale using a sensor. The method further includes determining if the length of twine reaches a threshold for the bale using a control module operatively connected to the sensor. After reaching the threshold, activating an actuator on the agricultural baling machine by the control module and then the method further includes tying the twine for the bale to secure the bale wherein the tying the twine is performed using a knotter of the agricultural baling machine activated with the actuator. The method may further include activating one or more bale stop members protruding into a bale chamber of the agricultural baling machine such that the one or more bale stop members stop movement of crop material to control the bale length when the length of twine reaches the threshold. Each of the one or more bale stop members may be a bale stop roll. Each of the one or more bale stop rolls may include a traction mechanism attached thereon. The traction mechanism may include cleats. The sensor may include an electrical encoder, and the actuator may include a solenoid.

According to another aspect, an apparatus for an agricultural baler having a bale chamber is provided. The apparatus includes a first sensor configured to measure length of twine and a control module operatively connected to the first sensor and configured to determine when a threshold is reached for stoppage of a bale using the length of twine and triggering a knotter. The apparatus may further include a plurality of bale stop members configured to protrude into the bale chamber, at least one actuator operatively connected to the control module, and each of the plurality of bale stop members may be operatively connected to one of the at least one actuator to provide for stopping movement of a first formed end of the bale on the agricultural baler when the bale reaches the threshold. Each bale stop member may have its own separate actuator which may be a hydraulic actuator and the apparatus may further include an electronically activated shut off valve electrically connected to the control module, the electronically activated shut off valve fluidly connected to the hydraulic actuator such that activation of the electronically activated shut off valve by the control module stops hydraulic fluid flow to each of the plurality of bale stop members thereby stopping movement of the plurality of bale stop members and limit length of the bale. The apparatus may further include a second sensor associated with one of the plurality of bale stop members for measuring rotation of the bale stop member such as a rotary encode. Each bale stop member may have its own sensor. The apparatus may further include a monitor in operative communication with the control module wherein the monitor is configured to display bale length settings.

According to another aspect, an agricultural baler includes a bale chamber, at least one hydraulic actuator, a sensor configured to measure twine, and a control module operatively connected to the sensor and configured to determine when a threshold is reached for stoppage of a bale. The control module may be further configured to determine bale length using twine length for a first portion of a bale and at least one additional measurement for a last portion of the bale. The agricultural baler may further include at least one hydraulic actuator, and a plurality of bale stop rolls configured to protrude into the bale chamber. Each of the plurality of bale stop rolls may be operatively connected to one of the at least one hydraulic actuator to provide for stopping movement of a first formed end of the bale on the agricultural baler when the bale reaches the threshold. The baler may further include shutoff valve operatively connected to the at least one hydraulic actuator and configured to stop movement of each of the plurality of bale stop rolls. The baler may further include at least one bale stop roll sensor configured to measure movement of a corresponding one of the plurality of bale stop rolls. The movement of the corresponding one of the plurality of bale stop rolls may be used in determining the at least one additional measurement for the last portion of the bale. The baler may further include a monitor in operative communication with the control module. The monitor may include a display with a user interface configured to receive a desired bale length from a user. The agricultural baler may be configured to check bale length prior to completion of forming a bale and change a bale length setting thereby adjusting timing of stopping movement of the plurality of bale stop rolls to control the bale length.

### BRIEF DESCRIPTION OF THE DRAWINGS

FIG. 1 is a block diagram providing an overview of one aspect of the present disclosure.

FIG. 2 illustrates monitoring of bale length by measuring twine or wire using the electrical encoder system.

FIG. 3 illustrates a needle frame sensor.

FIG. 4 illustrates a bale chamber with the bale stop rolls.

FIG. 5 illustrates monitoring bale length by measuring twine using the electrical encoder system.

FIG. 6 illustrates the baler with a hydraulic actuator mounted to it.

FIG. 7 further illustrates additional hydraulic components.

FIG. 8 illustrates one example of a bale stop roll which protrudes into the bake chamber.

FIG. 9 illustrates portions of the hydraulic system.

FIG. 10 further illustrates a bale stop roll which protrudes into the bale chamber.

FIG. 11 further illustrates a bale stop roll which protrudes into the bale chamber.

FIG. 12 is another view of the bale stop roll.

FIG. 13 illustrates one example of a process for controlling bale length.

FIG. 14 illustrates a screen display or graphical user interface on a monitor.

FIG. 15 illustrates a pressure relief valve to release chamber pressure.

FIG. 16 illustrates the hydraulic actuator sitting a top a bale stop roll which is enclosed.

FIG. 17 illustrates a portion of an inside of a baling chamber showing a bale stop member.

FIG. 18 illustrates one example of a control module.

FIG. 19 illustrates another view of the hydraulic actuator and other portions of the hydraulic system.

FIG. 20 illustrates another view of a bale stop member from outside of the baler.

FIG. 21 illustrates measuring twine using the electrical encoder system.

FIG. 22 illustrates a knotter trip solenoid.

### DETAILED DESCRIPTION

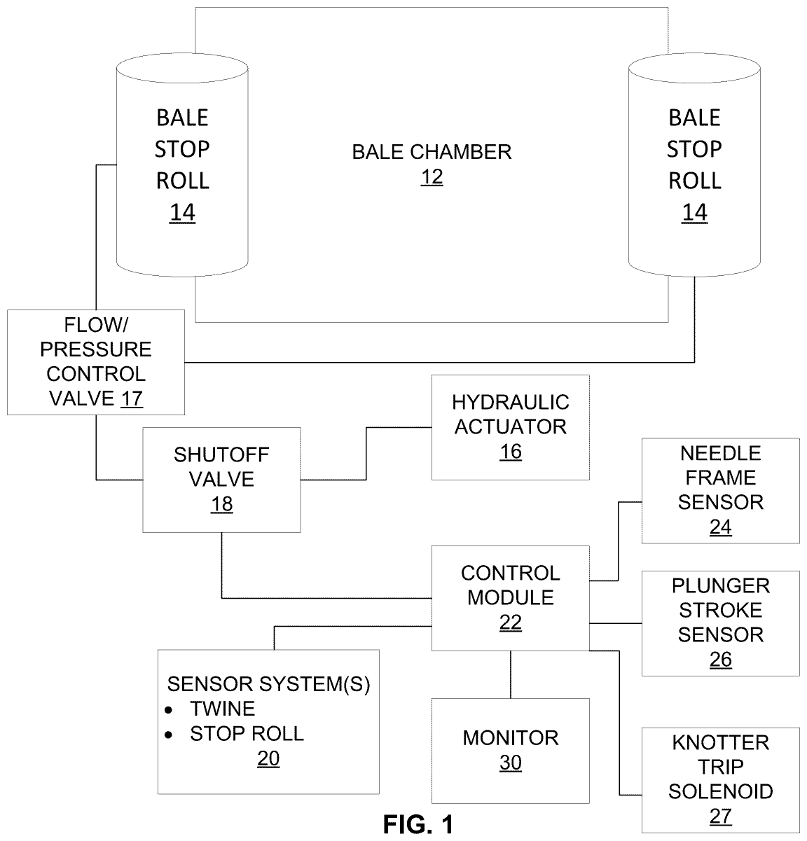

FIG. 1 is a block diagram providing an overview of one aspect of the present disclosure. As shown in FIG. 1 is a simplified view of a bale chamber 12 such as may be present in a square baler. The bale chamber 12 is a generally enclosed space in which the crop is collected, compressed, and formed into a dense rectangular bale. The bale chamber 12 may generally have smooth metal walls and a floor to facilitate easy movement and compression of the crop material. Adjustable tension rails or springs may be present along the sides and top to control the pressure applied to the bale and thereby in turn control its density and shape. A reciprocating plunger (not shown) may be positioned at one end of the bale chamber and as it moves back and forth may compress the incoming crop material into a denser form.

There may be one or more bale stop members which may be in the form of bale stop rolls 14 present. For example, there may be bale stop rolls 14 present on opposite walls of the bale chamber 12, such as on opposite side walls as shown or on the top and bottom of the bale chamber 12 or on both opposite side walls as well as the top and the bottom of the bale chamber. Although one bale stop roll 14 is shown on each of the left and right side, it is to be understood that multiple bale stop rolls may be present on the left side, the right side, the top, and/or the bottom.

Each of the bale stop rolls 14 may be formed from one or more bearing mounted rotating rolls with a traction mechanism. The traction mechanism is a physical structure which provides traction for the bale stop roll. Examples of traction include protrusions extending from the surface of the bale stop roll of any number of shapes and sizes, such as would be provided by any arrangement of cleats. Alternatively, the bale stop rolls may include belts or chains which protrude into the bale chamber at a preferred depth and may be supported between two or more points.

A hydraulic actuator 16 is shown such as a hydraulic motor, hydraulic pump, or other hydraulic device. The hydraulic actuator 16 may provide for moving hydraulic fluid through a hydraulic system. It is to be understood that a hydraulic system may also include other hydraulic components such as gears, filters, coolers, and the like. By creating flow, pressure is generated which is needed to perform work. Here, the hydraulic system may be used to control or limit movement or rotation of the bale stop rolls. This prevents the bale stop rolls from moving too quickly or abruptly as there is resistance to movement. Such abrupt motion may occur due to plunger strokes or may be caused for other reasons. Thus, motions such as jerks or other abrupt motions are eliminated, and smoother operation is provided through use of the hydraulic system and bale stop rolls. It is to be understood that hydraulics used for the bale stop member may be incorporated into or otherwise integrate into other hydraulics systems of the baler.

FIG. 1 further illustrates a flow and/or pressure control valve 17 which is fluidly connected to the hydraulic actuator 16 and may be used to control the flow or pressure control in order to control the resistance provided by the bale stop roll 14. The flow and/or pressure control valve 17 may be manually adjusted. It is contemplated that alternatively, the flow and/or pressure control valve 17 may be operatively connected to the control module 22 and may be set electronically.

One or more sensor systems 20 may be present. The sensor systems 20 may include sensors for twine measurement as well as sensors for bale stop roll movement. Thus, the sensor systems provide data for use by the control module 22 which may be sufficient to determine a length of twine and/or length of bale associated with a first portion of a bale as well as the length of bale associated with a last portion of the bale which may be the last flake of the bale. Thus, the senor system 20 may include a bale stop member sensor for determining rotation of the bale stop roll 14. Such as sensor may be an encoder such as a rotary encoder. In addition, the sensor system 20 may include an encoder or other sensor for measuring twine length.

It is contemplated that a sensor system 20 may have a sensor present for each bale stop roll 14, or only one bale stop roll 14. Each sensor in the sensor system 20 may be in the form of an electrical encoder system such as a rotary encoder. The sensor system 20 may be used to measure or sense bale length. One way to monitor bale length is by measuring twine or wire using the sensor system. A signal from the sensor system 20 such as a rotary encoder or other twine length measuring system may be communicated to control module 22. Once the measurement reaches a threshold associated with desired bale length, a shutoff valve 18 may be activated which will stop hydraulic fluid flow and result in the bale stop rolls 14 stopping movement, thereby limiting bale length. The shutoff valve 18 may be in operative communication with the control module 22 such that when the control module 22 determines that twine length (or other measure of bale length) has been reached, the shutoff valve 18 which may comprise an electronic solenoid may be activated.

Each sensor system 20 may include a bale stop member sensor which may be positioned at bottom of a corresponding stop roll 14, a top of the corresponding stop roll 14 or otherwise. The sensor system 20 may thus measure rotation of the corresponding bale stop roll 14 for the last flake of the bale. Thus, rotary encoding is one sensing methodology which may be used, but other types of proximity sensors may be used.

Any number of different types of sensors may be used to sense bale length or one or more physical parameters associated with bale length. In operation, once bale length is determined such as by measuring twine through an electronic encoder system (or other sensor), then the system determines when the backend or first formed end of the bale needs to be stopped. It should be understood that the backend or first formed end of the bale is stopped on the baler, the baler would continue to travel in normal operation. It should be noted that this manner of measuring twine (or wire) to determine bale length is not known to be present on other systems such as where rotation of star wheel or a cog might be used. Moreover, this method of measuring twine is advantageous in providing greater accuracy and directly measuring twine length. Because the twine length is around double the bale length because the twine encircles the bale, this is a higher resolution measurement.

It is also to be understood that two different methods may be used to measure bale length. For the first portion of the bale, up to the last flake, a sensor to measure twine length may be used. However, a separate sensor may be used to measure length of the last portion of the bale. Where roll members are used, the rotation of the roll members may be sensed. Both the sensors for measuring twine as well as the sensors for measuring roll member rotation may be a part of the sensor system 20 which is operatively connected to the control module 22. It is, however, contemplated that in some embodiments more conventional systems such as a star wheel or cog may be used when measuring the last flake of the bale. It should be understood that in the present disclosure one method may be used to measure all but the last flake of a bale and a different method is used for measuring the last flake in order to maintain consistent bale length.

The inline electronic shutoff valve 18 may be activated when the system determines a bale has reached its full length or set length and is ready to tie. When the inline shutoff valve is activated, hydraulic fluid flow will be stopped, and this will lock up the hydraulic actuator 16 which will then lock up the bale stop rolls 14 taking control of the bale's length. It should be understood that in some embodiments there may be a hydraulic actuator 16 for each bale stop roll 14 and in other embodiments a single hydraulic actuator 16 may be used.

The control module 22 may also be operatively connected to a needle frame sensor 24 and a plunger stroke sensor 26. The control module 22 may be further operatively connected to a monitor 30 which may be an in-cab module with a display or touchscreen display. The monitor may be used to display information about baling operations such as bale count, plunger strokes per minute, plunger strokes per hour, bales per hour, bale length or information.

In addition, the monitor 30 may be used to instruct the control module regarding bale length, such as by adjusting a threshold associated with activating a shutoff valve. Additional methods may be used to control bale length as will be discussed in more detail.

FIG. 1 further includes a knotter trip solenoid 27 which is operatively connected to the control module 22. When the knotter trip solenoid 27 is activated, the knotter initiates completion of tying of a bale.

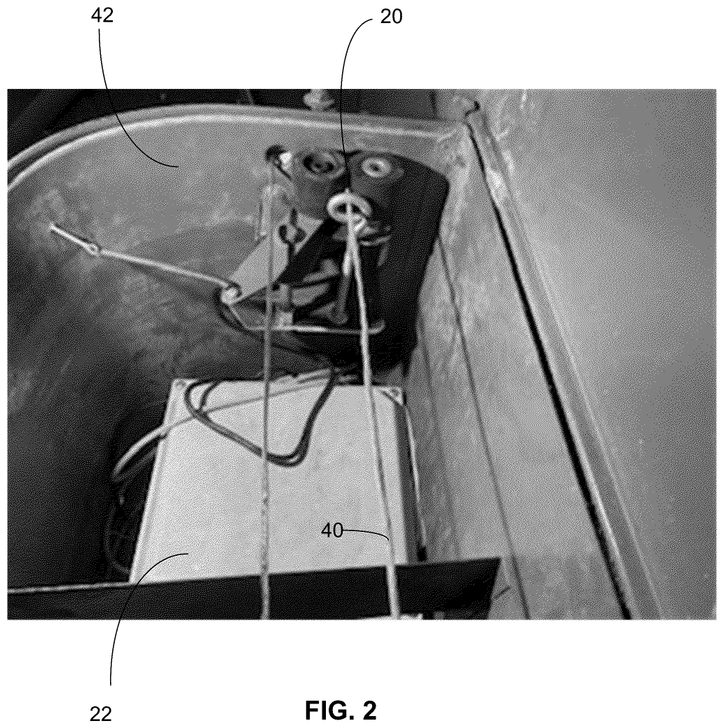

FIG. 2 illustrates monitoring of bale length by measuring twine or wire using the sensor system 20 which may be an electrical encoder system which includes a rotary encoder to measure length of the twine 40. A control module 22 is shown below the twine 40 which may be located in a forward compartment box 42 of the baler.

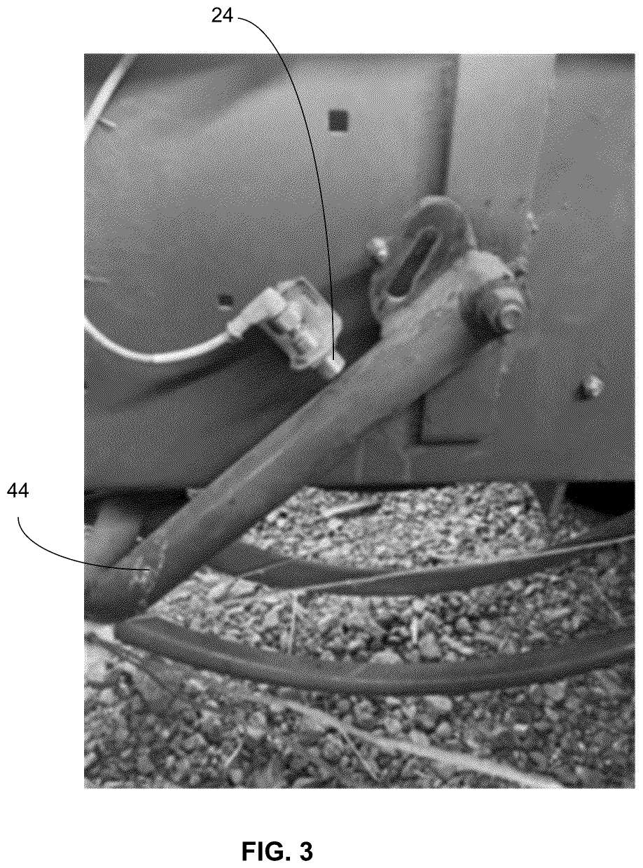

FIG. 3 illustrates a needle frame sensor 24 mounted at the needle frame 44 of the baler in order to monitor position of the needle frame 44 so as to monitor when needles leave or return. This allows the control module 22 to monitor the stage of the baling operation. The needle frame 44 is the structural framework of the baler that supports the needles and ensures their correct alignment and position. The needle frame thus helps correctly position the twine for the knotter to function effectively. Movement of the needle frame 44 may be synchronized with the plunger and knotter mechanism to allow for smooth operation and to avoid jams and mis-ties.

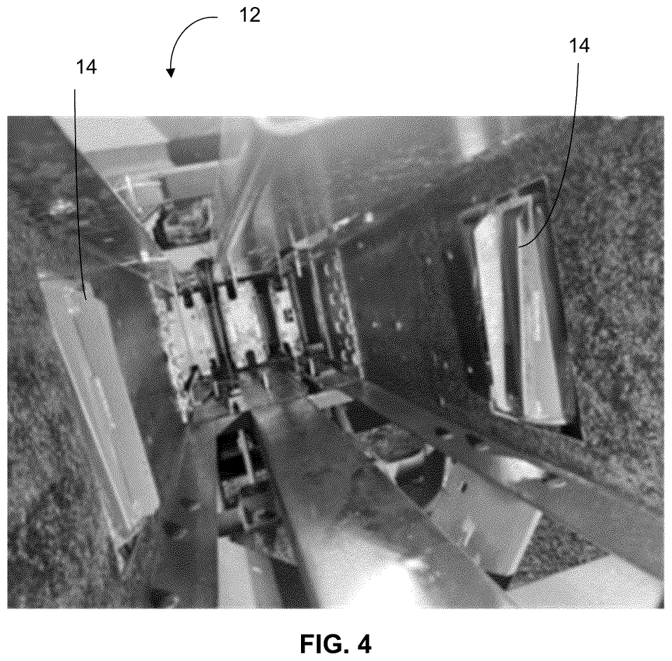

FIG. 4 illustrates a bale chamber 12 of the baler with the bale stop rolls 14 present on opposite left and right sides. The bale stop rolls 14 protrude into the bale chamber 12.

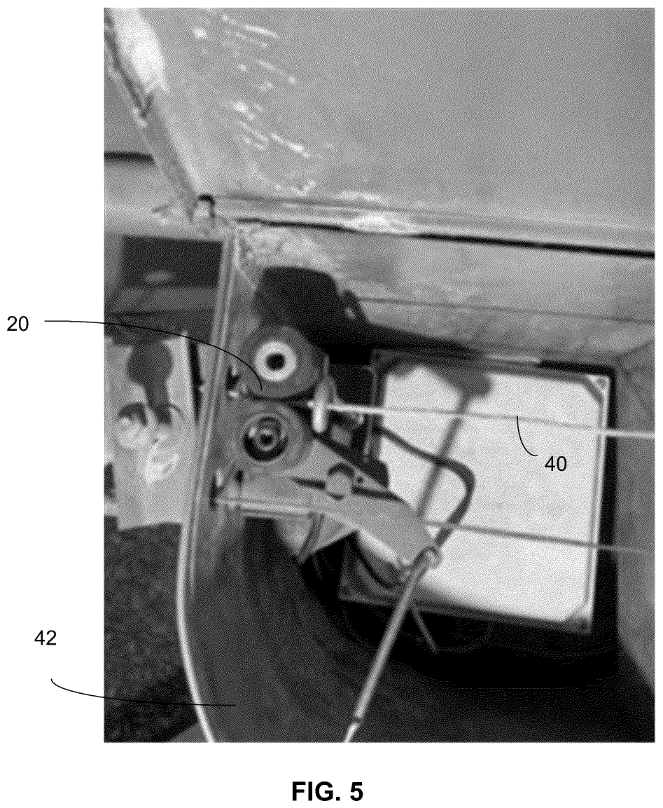

FIG. 5 further illustrates monitoring bale length by measuring twine 40 using the electrical encoder system 20 which is operatively connected with a control module within the forward compartment box 42 of the baler.

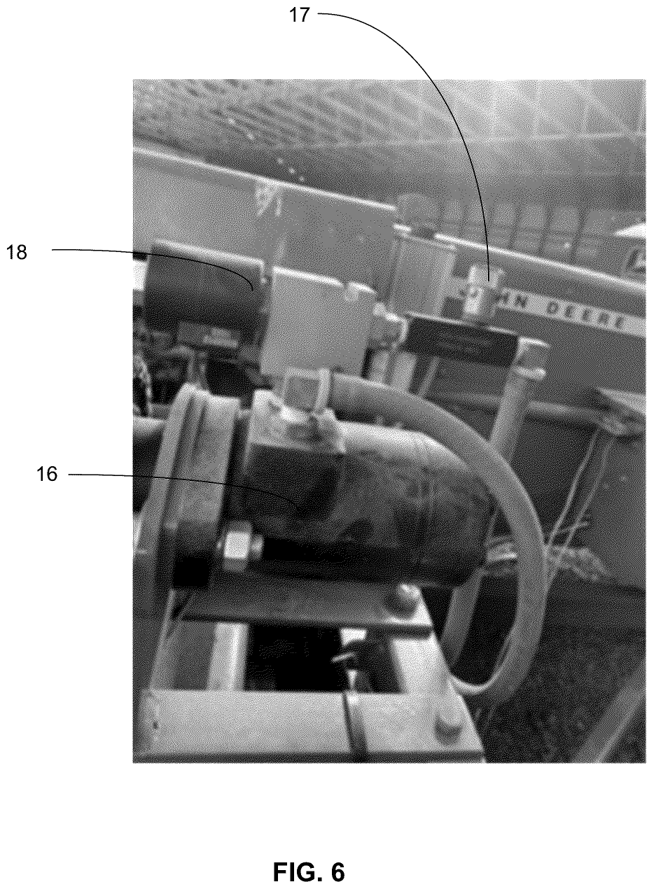

FIG. 6 illustrates the baler with a hydraulic actuator 16 mounted to it. A shutoff valve 18 which may include an electronically actuated solenoid is fluidly connected to the hydraulic actuator 16 with a flow and/or pressure control valve 17 fluidly connected therebetween.

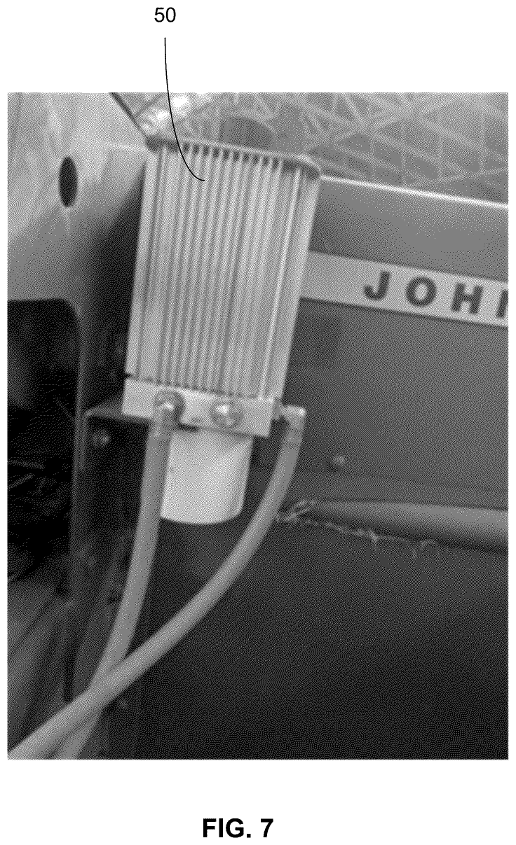

FIG. 7 further illustrates additional hydraulic components 50 which may include a reservoir, filter, and cooler in the same unit. Of course, it is to be understood that any number of different hydraulic components may be used including a gear box, depending upon the particular implementation used.

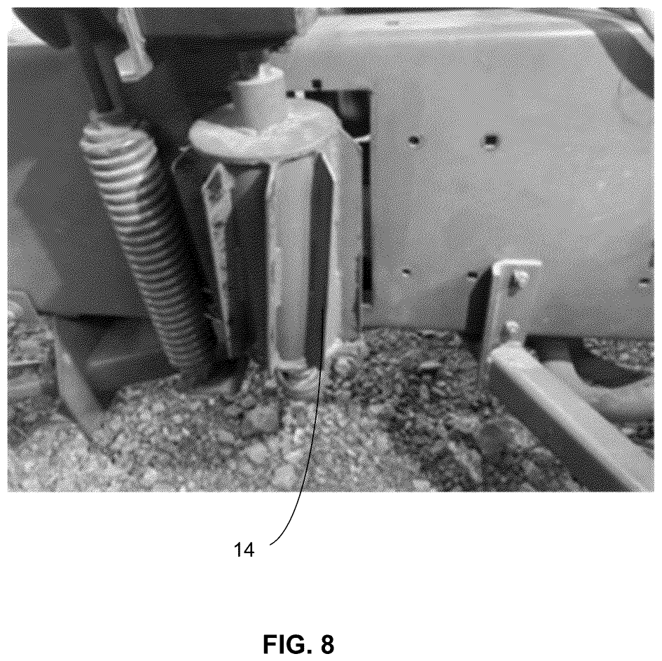

FIG. 8 illustrates one example of a bale stop roll 14 which protrudes into the bale chamber. The bale stop roll shown has cleats attached along the length of the outer cylindrical surface in order to provide traction. The cleats shown are in the form of fins. It is to be understood that the traction mechanism may be of any number of different geometries or shapes and need not have the same size, shape, placement, or number as the cleats shown. The traction mechanism provides resistance to slow movement and stop movement of a bale as it is being formed in the bale chamber in order to control length.

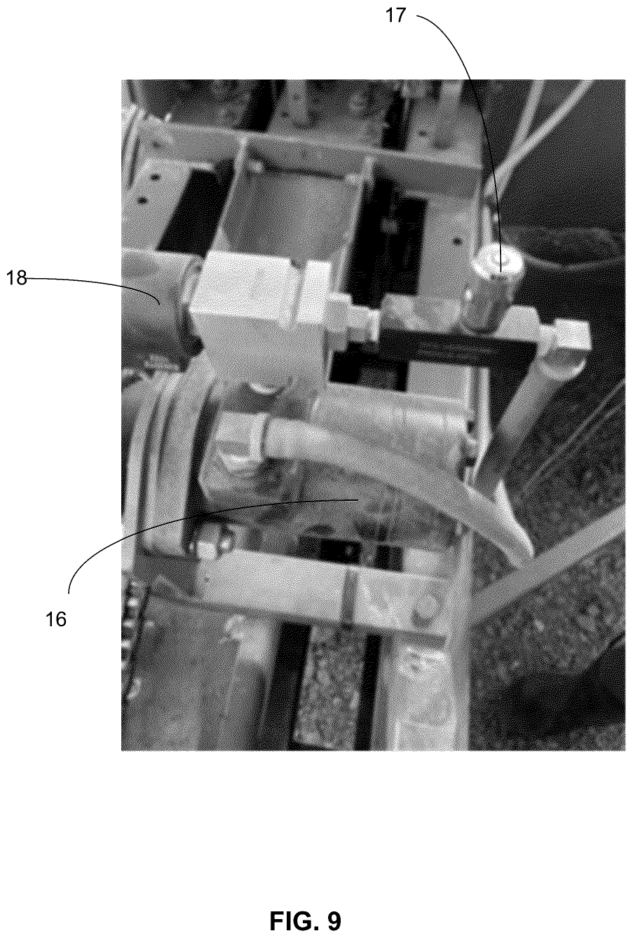

FIG. 9 further illustrates the hydraulic actuator 16 and the shutoff valve 18 with the flow and/or pressure control valve 17 fluidly connected therebetween.

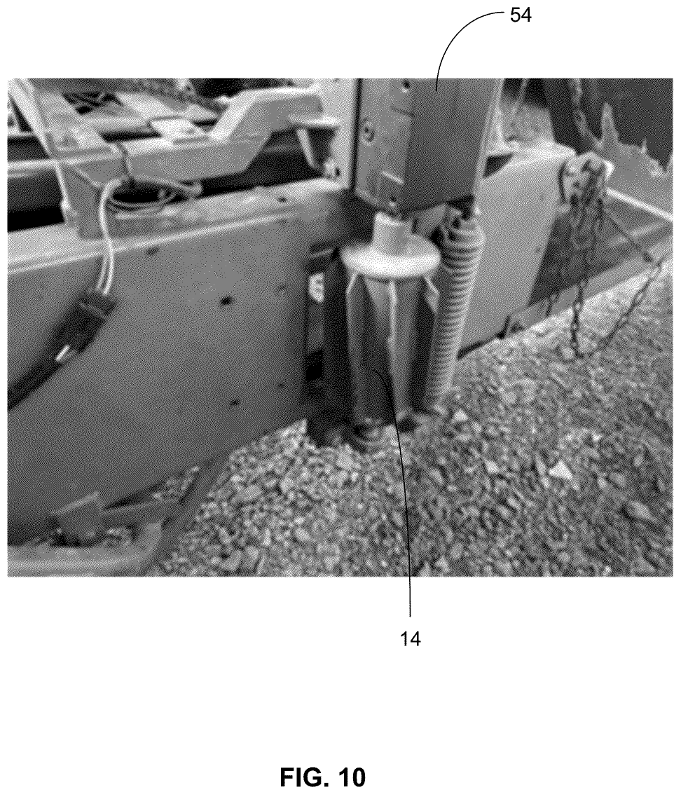

FIG. 10 further illustrates a bale stop roll 14 which protrudes into the bale chamber. Above the bale stop roll 14 a gear box 54 is shown. It should be understood that a gear box 54 need not be used.

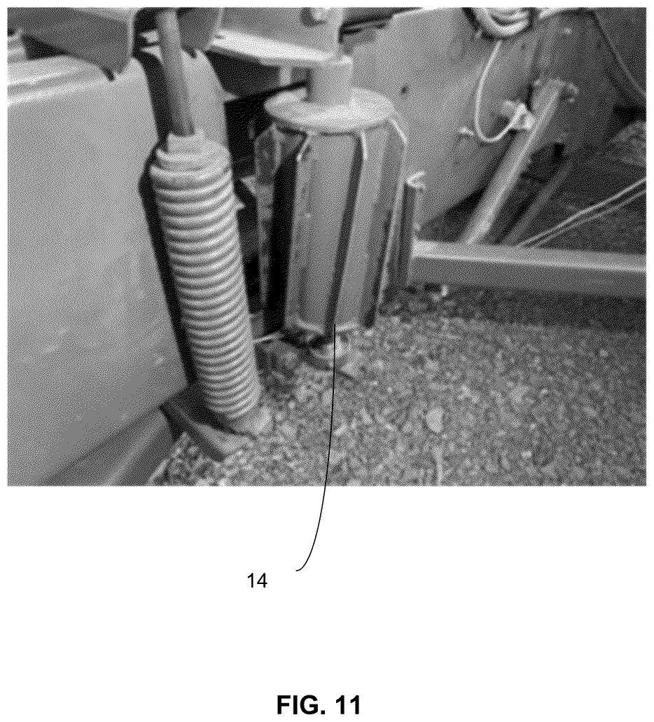

FIG. 11 further illustrates a bale stop roll 14 which protrudes into the bale chamber.

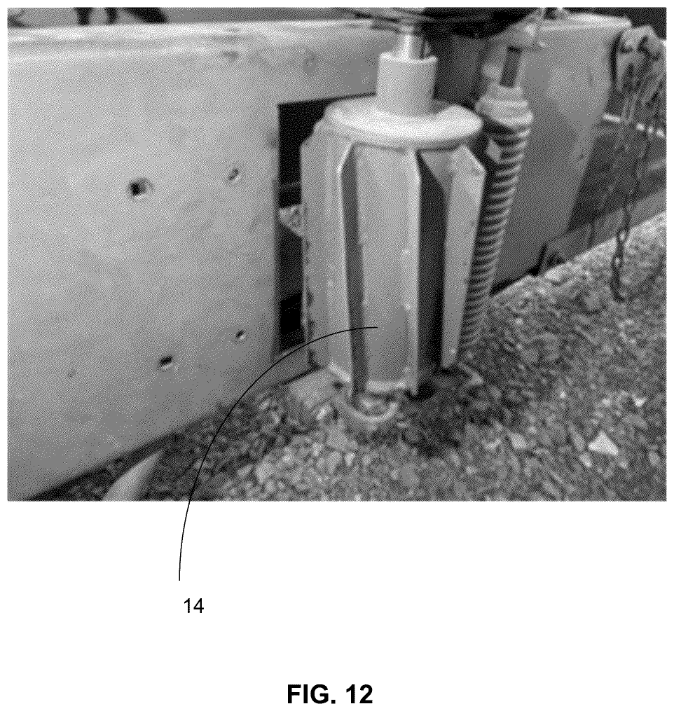

FIG. 12 is yet another view of the bale stop roll 14.

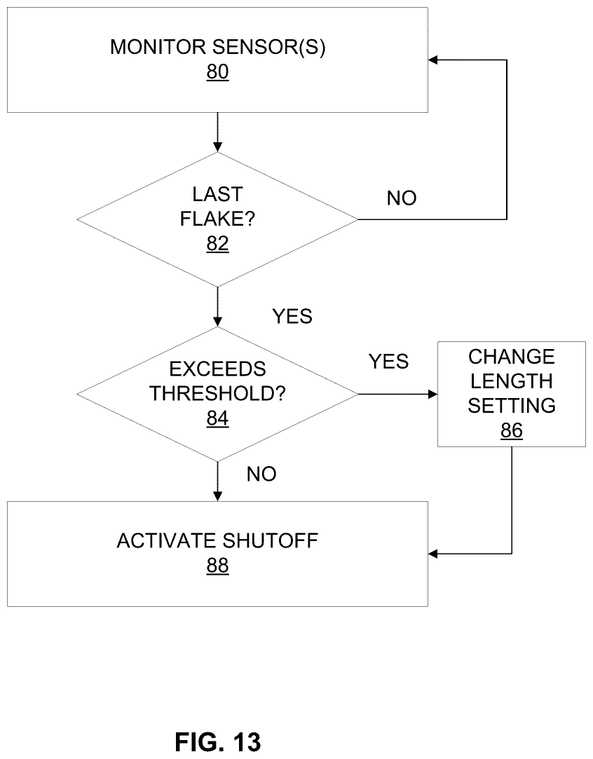

FIG. 13 illustrates one example of a control methodology for controlling bale length. As previously mentioned, the electrical encoder system or other type of sensor may be used to determine bale length based on twine length.

In step 80, one or more sensors are monitored. This may include the bale length sensor which may be the electrical encoder system previously described. This may further include the plunger stroke sensor which determines the state or position of the plunger. In step 82, a determination is made as to whether the baler is on its last flake for the current bale. The last flake would correspond with a last plunger action to compress the last portion of crop material to form the end of the bale. One way of determining if the baler is on its last flake is by counting the number of times a plunger compresses crop material, where a consistent number of plunger activations are used per bale. Other ways of determining if the baler is on its last flake include by evaluating the bale length as determined by the amount of twine used and determining if additional flakes will be required. If the baler is not on its last flake, then the process may return to the monitoring of sensors. If the baler is on its last flake for a bale, then in step 84, a determination may be made as to whether the bale length is likely to exceed a threshold bale length. To make this determination, an average flake length (or thickness) for previous flakes may be used. For example, the average flake length or thickness for the 10 previous flakes may be calculated. If the bale length for the current bale is likely to exceed the desired bale length then in step 86, the bale length setting may be decreased. For example, if an additional flake of an average size based on an average of previous flake sizes in addition to the bale length determined from the amount of twine used thus far indicates the bale length with the additional flake will exceed a threshold size, then the bale length setting may be decreased. Then in step 88, the shutoff valve may be activated. If in step 84, the threshold is not exceeded, then no adjustment to the length setting is made.

The shutoff is activated based on desired bale length and so when there is a shorter bale length setting the shutoff is activated and the bale stop rolls are activated sooner which results in a shorter bale length. Thus, this methodology results in more consistent bale lengths over time through a dynamic process. Before (or sometimes generally simultaneously) the shutoff being activated, the knotter of the baler is triggered such as with a mechanical trip arm or electronic sensor to tie the twine to secure the bale. For example, a knotter trip solenoid may be activated by the control module to trigger the knotter to tie the bale. Then the shutoff is activated.

Although a particular method is shown and described it is to be understood that various options, and alternative methods may be used. For example, instead of an average flake length, a threshold may be determined in other ways. Instead of looking at the most recent 10 flakes, different sizes of windows may be used. In addition more complex methods and algorithms may be used which can take into account any number of different variable, sensor measurements, user settings, or the like.

It is further to be understood that the logic for performing the methods described may be performed by electronics in the control module, in the monitor, or a combination thereof with some portions of the logic performed in the control module and some in the monitor. Each of the control module and the monitor may have an intelligent control such as a microcontroller or processor configured to execute a set of instructions stored on a non-transitory machine readable medium.

It is to be further understood that the monitor may provide a graphical user interface which allows the user to set a desired bale length. In addition, the graphical user interface may provide feedback to the user on a baling operation as previously described.

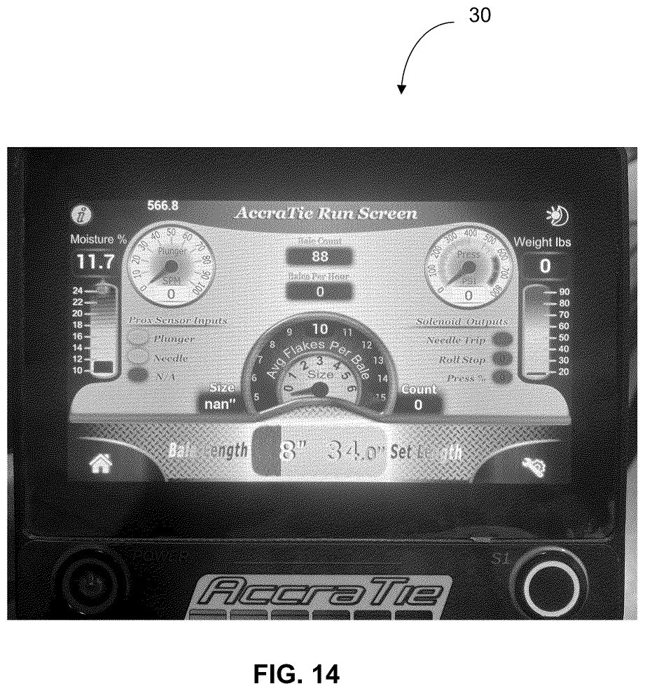

FIG. 14 provides one example of monitor 30. The monitor 30 provides a graphical user interface which allows an operator to set parameters and monitor baling activity. This includes monitoring bale count, monitoring bale count per hour, monitoring the average number of flakes per bale, monitoring the size of flakes (such as in inches). The monitor may also be used for monitoring the weight of the bales. The monitor 30 may also be used to monitor the number of strokes per minute for the baler as well as the pressure. The monitor 30 may be configured to display a percent moisture of a bale and weight of a bale. Inputs and outputs may also be monitored including proximity sensor inputs for the plunger and needle and solenoid outputs for the needle trip, the roll stop and the pressure percentage. The monitor 30 may also provide for displaying bale length and allow for a user to set the desired length for the bale.

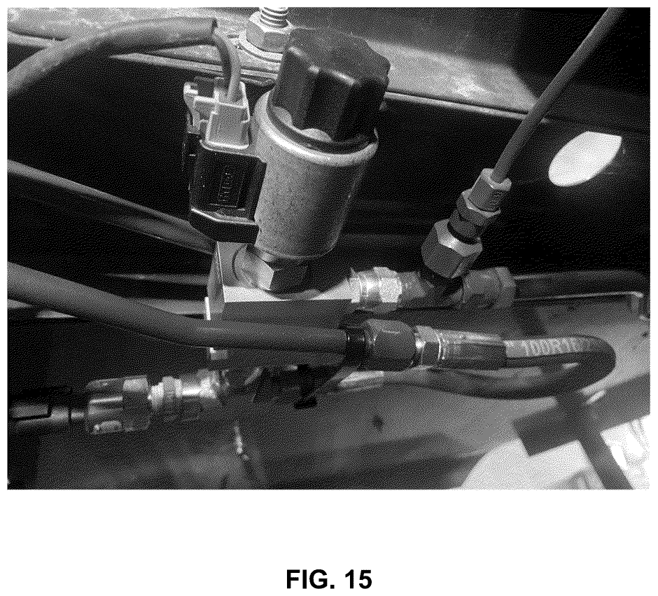

FIG. 15 through 22 illustrate another example of an agricultural baler configured for more consistent baling. The baler shown in FIG. 15 through FIG. 22 is similar to that previously shown however, it includes a hydraulic actuator for each bale stop member.

FIG. 15 illustrates an example of a pressure relief valve to release chamber pressure. It is to be understood that the hydraulic systems for the baler which may be conventionally present and for the hydraulic pressure systems for the rollers may be separate or may be integrated.

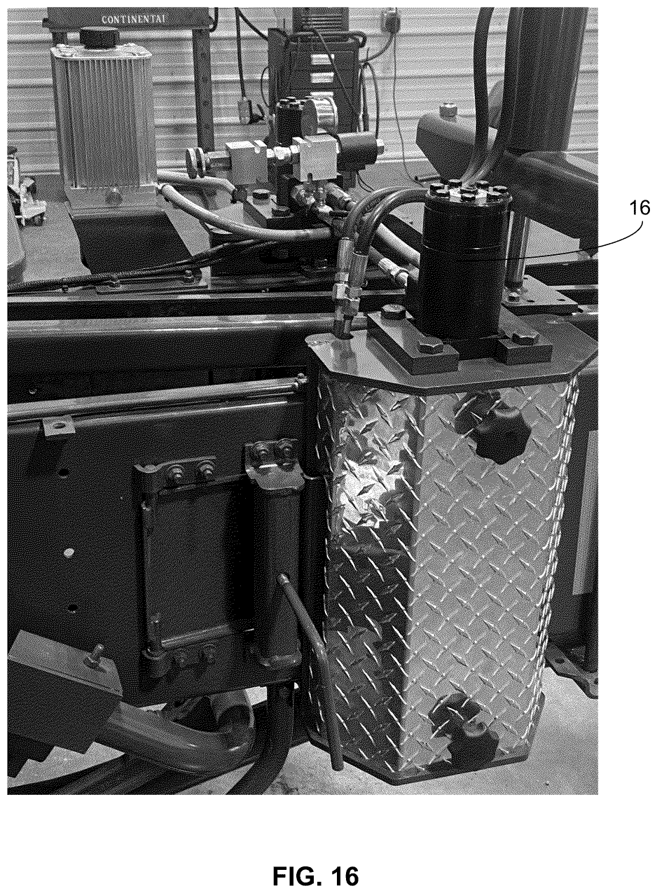

FIG. 16 illustrates the hydraulic actuator 16 sitting atop a bale stop roll which is enclosed with a removable protective cover.

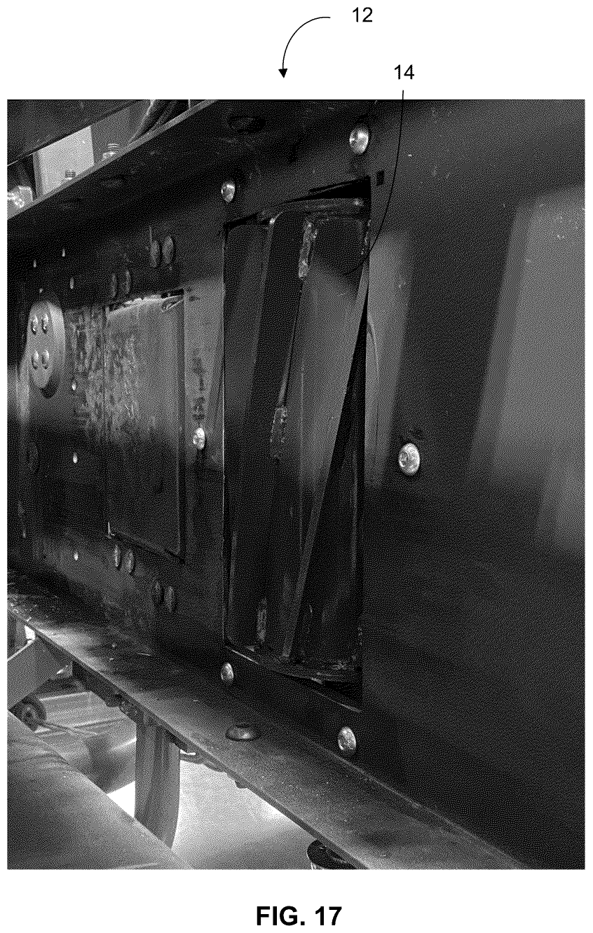

FIG. 17 illustrates a portion of an inside of a baling chamber 12 showing a bale stop member 14 in the form of a bale stop roll. Note another bale stop member (not shown) may be positioned on the opposite side of the baling chamber 12.

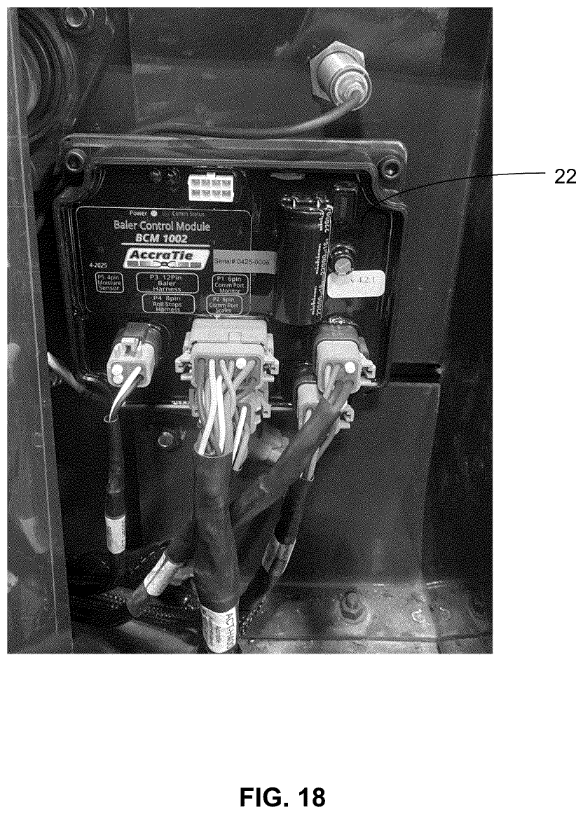

FIG. 18 illustrates one example of a control module 22. Note various connections to sensors and actuators are shown which provide inputs and outputs to and from the control module 22.

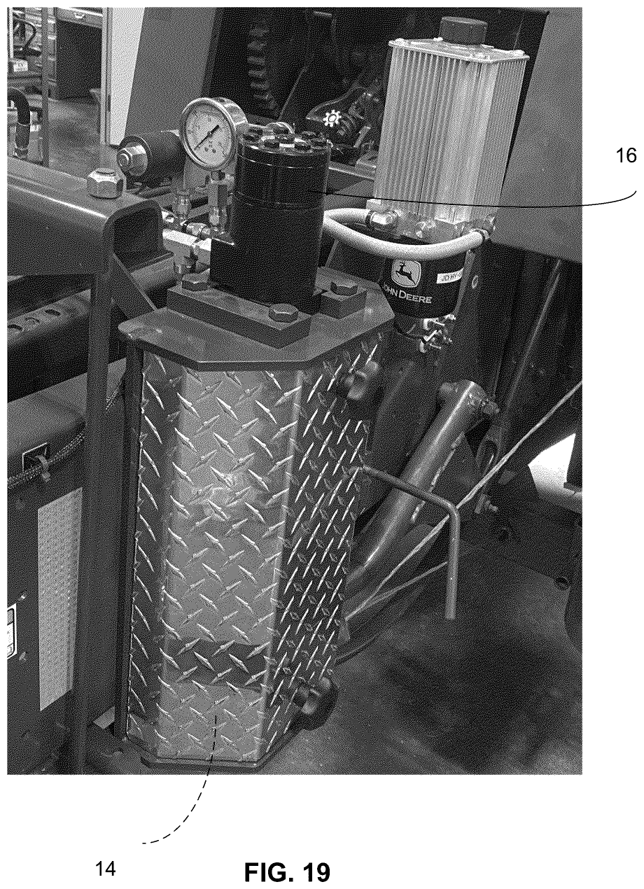

FIG. 19 illustrates another view of the hydraulic actuator and other portions of the hydraulic system. A bale stop member 14 is housed within the protective enclosure shown.

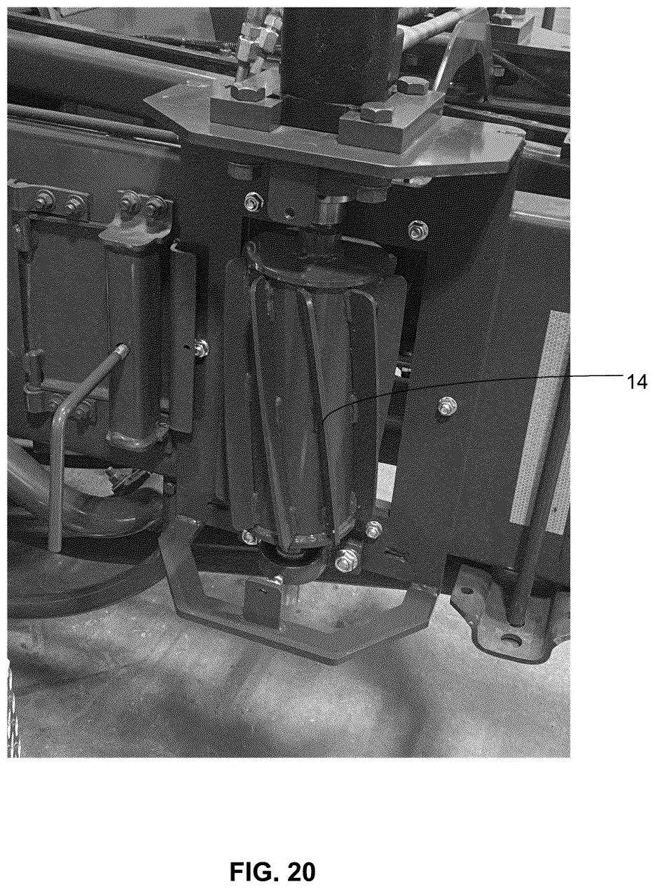

FIG. 20 illustrates another view of a bale stop member 14 from outside of the baler when the protective cover is removed.

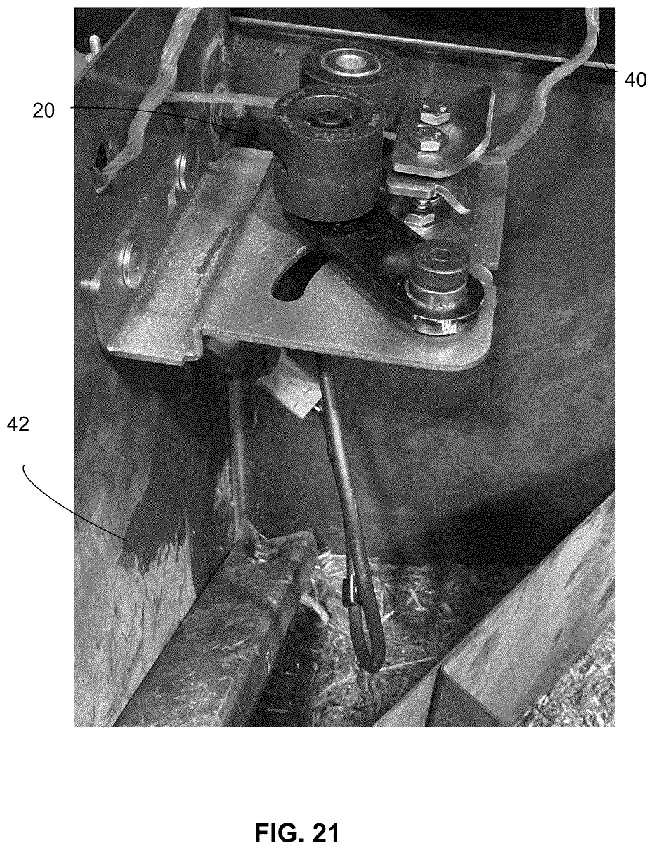

FIG. 21 illustrates measuring twine 40 using the sensor of the sensor system 20. The sensor may be a rotary encoder as shown for measuring the twine 40 and this may be located in a forward compartment box 42.

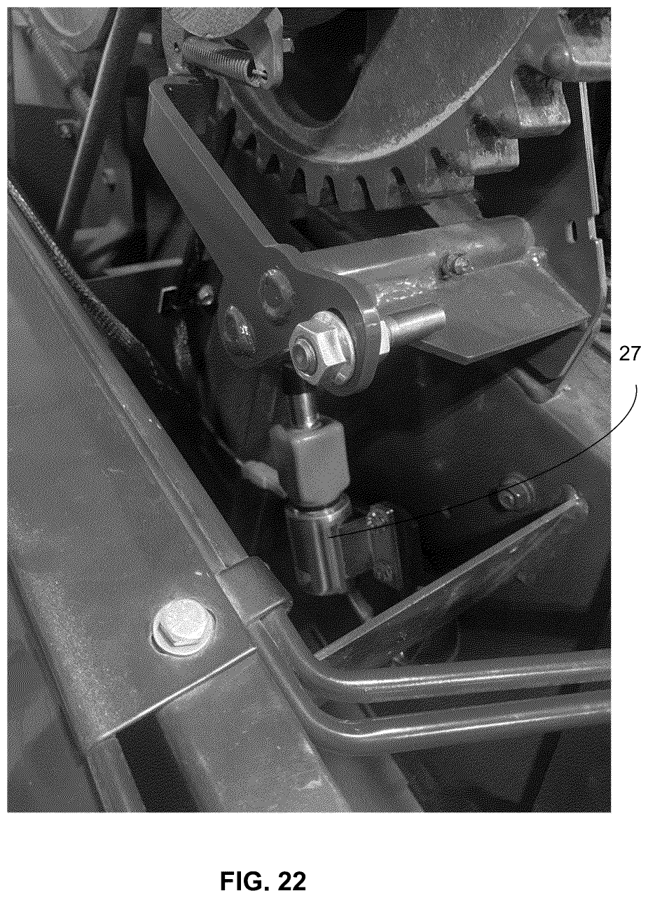

FIG. 22 illustrates an example of a knotter trip solenoid 27 mounted on the baler.

The agricultural baler shown and described is advantageous in numerous ways. First, using a sensor to measure twine length such as an optical encoder provides for more accurate measurement of bale length than traditional methods such as using a star wheel. One reason is the length of the twine is longer than the length of the bale because the twine wraps all away around the bale. Thus, using twine length measured with a sensor is higher resolution and more accurate information than using a star wheel. Moreover, being able to measure twine length is advantageous for other purposes such as for tracking the amount of twine used, or the amount of twine remaining. In some embodiments, when twine is replenished, the amount of twine added may be input on the display or otherwise input and as the twine is consumed, the amount of twine used may be deducted from a total remaining. A visual indicator, audible indicator, or other alert may be activated when the amount of twine remaining passes a threshold associated with the alert. In addition, the amount of twine remaining may be displayed to the operator at any time or continuously during baling operations.

It should also be understood that two different measurement systems may be used for a bale. The first measurement system may measure the amount of twine and may be used for all but the last flake and the second measurement system may be used for the last flake. Thus, in some embodiments, the amount of twine may be measured with a sensor and then for the last flake an alternative method of sensing may be used such as using an encoder to measure rotation of the rolls. If the rolls are not present then an alternative method may be used such as a star wheel, cog, or other mechanism. A sensor system may be configured to provide for obtaining both types of measurements.

It should further be understood that just by measuring twine and tripping the baler when the amount of twine reaches a threshold, the bale length variation is improved. However, further using the stop rolls for the last flake further improves bale length variation.

Although the system has been described in terms of a hydraulic system, it is to be understood that instead of a hydraulic system other types of systems may be used including systems with electronic motors or other actuators instead of electronic actuators, or mechanical braking systems instead. Such systems may be used to generate sufficient resistance to stop the bale stop rolls, or more generally, bale stop members which need not act as rolls. However, the use of rolls is generally advantageous as it allows for smoother movement and avoids abrupt motion.

It is to be further understood that in some embodiments, multiple bale stop members may protrude into the bale chamber and belts or chains may be connected therebetween.

In some embodiments, the distance which the stop members protrudes into the bale chamber may be adjustable. This may be accomplished in a variety of different ways. For example, the bale stop members may be spring loaded so that spring tension may be set corresponding to a desired depth. Alternatively, other adjust mechanisms may be used. For example shims may be used to control depth. Alternatively, different sizes or geometries of stop members may be removed and replaced with alternative sizes. Thus for example, when baling one type of crop, one size may be used, but when baling a different type of crop another size may be used. It is contemplated that where a control system is used that the control system may be calibrated for different types of bale stop rolls or bale stop members or adjustable bale stop rolls or bale stop members.

Although various embodiments have been shown and described, the present disclosure contemplates any number of different options, variations, and alternatives and is not to be limited to the specific embodiment shown.

1. A method of controlling bale length of a bale in an agricultural baling machine, the method compromising:
monitoring length of twine for the bale using a sensor;
determining if the length of twine reaches a threshold for the bale using a control module operatively connected to the sensor;
after reaching the threshold, activating an actuator on the agricultural baling machine by the control module; and
tying the twine for the bale to secure the bale wherein the tying the twine is performed using a knotter of the agricultural baling machine activated with the actuator.

2. The method of claim 1 further comprising activating one or more bale stop members protruding into a bale chamber of the agricultural baling machine such that the one or more bale stop members stop movement of crop material to control the bale length when the length of twine reaches the threshold.

3. The method of claim 2 wherein each of the one or more bale stop members is a bale stop roll.

4. The method of claim 3 wherein each of the one or more bale stop rolls comprises a traction mechanism attached thereon.

5. The method of claim 4 wherein the traction mechanism comprises cleats.

6. The method of claim 1 wherein the sensor comprises an electrical encoder and the actuator comprises a solenoid.

7. An apparatus for an agricultural baler having a bale chamber, the apparatus comprising:
a first sensor configured to measure length of twine; and
a control module operatively connected to the first sensor and configured to determine when a threshold is reached for stoppage of a bale using the length of twine and triggering a knotter.

8. The apparatus of claim 7 further comprising:
a plurality of bale stop members configured to protrude into the bale chamber;
at least one actuator operatively connected to the control module; and
each of the plurality of bale stop members operatively connected to one of the at least one actuator to provide for stopping movement of a first formed end of the bale on the agricultural baler when the bale reaches the threshold.

9. The apparatus of claim 8 wherein the at least one actuator includes a separate actuator for each of the plurality of bale stop members.

10. The apparatus of claim 9 wherein the actuator is a hydraulic actuator and the apparatus further comprising an electronically activated shut off valve electrically connected to the control module, the electronically activated shut off valve fluidly connected to the hydraulic actuator such that activation of the electronically activated shut off valve by the control module stops hydraulic fluid flow to each of the plurality of bale stop members thereby stopping movement of the plurality of bale stop members and limit length of the bale.

11. The apparatus of claim 8 further comprising a second sensor associated with one of the plurality of bale stop members for measuring rotation of the bale stop member.

12. The apparatus of claim 7 further comprising a monitor in operative communication with the control module wherein the monitor is configured to display bale length settings.

13. An agricultural baler comprising:
a bale chamber;
at least one hydraulic actuator;
a sensor configured to measure twine; and
a control module operatively connected to the sensor and configured to determine when a threshold is reached for stoppage of a bale.

14. The agricultural baler of claim 13 wherein the control module is further configured to determine bale length using twine length for a first portion of a bale and at least one additional measurement for a last portion of the bale.

15. The agricultural baler of claim 14 further comprising:
at least one hydraulic actuator;
a plurality of bale stop rolls configured to protrude into the bale chamber;
each of the plurality of bale stop rolls operatively connected to one of the at least one hydraulic actuator to provide for stopping movement of a first formed end of the bale on the agricultural baler when the bale reaches the threshold; and
a shutoff valve operatively connected to the at least one hydraulic actuator and configured to stop movement of each of the plurality of bale stop rolls;
at least one bale stop roll sensor configured to measure movement of a corresponding one of the plurality of bale stop rolls; and
wherein the movement of the corresponding one of the plurality of bale stop rolls is used in determining the at least one additional measurement for the last portion of the bale.

16. The agricultural baler of claim 15 further comprising a monitor in operative communication with the control module.

17. The agricultural baler of claim 16 wherein the monitor comprises a display with a user interface configured to receive a desired bale length from a user.

18. The agricultural baler of claim 17 wherein the agricultural baler is configured to check bale length prior to completion of forming a bale and change a bale length setting thereby adjusting timing of stopping movement of the plurality of bale stop rolls to control the bale length.
